(19) United States
(12) Patent Application Publication
(10) Pub. No.: US 2005/0177804 A1
(43) Pub. Date: Aug. 11, 2005

(54) Product selection, commercial and general arrangement integrated application

(75) Inventor: Jonathan Wilkinson, Wakefield (GB)

Correspondence Address: Edwin D Schindler, Five Hirsch Avenue, PO Box 966, Coram, NY, 11727-0966, US

(73) Assignee: AES Engineering Ltd., Rotherham (GB)

(21) Appl. No.: 10/508,400

(22) PCT Filed: Mar. 17, 2003
(86) PCT No.: PCT/GB03/01162

(30) Foreign Application Priority Data
Mar. 18, 2002 (GB) 0206338.6

(51) Int. Cl. G06F 17/00

(52) U.S. Cl. 715/964

(57) ABSTRACT

A system and related method for generating an illustration of a first device, with the first device being one device of a plurality of such devices, the system having a plurality of illustration templates with each illustration template corresponding to one device of the plurality of devices, a device for choosing one illustration template corresponding the first device of said plurality of devices, and a device for modifying the illustration template for the first device responsive to features of the first device for generating an illustration thereof.

Customer service is one of the key elements, which differentiates companies competing in the same industrial sectors.

Companies, which embrace and develop applications which help them improve their service levels to their customers, are more likely to grow or survive in a highly competitive world.

Many companies sell products with varying degrees of complexity.

Practically every man-made item that we see, use or touch is a product manufactured, distributed or offered by a company somewhere in the world.

A lot of products have multiple options or configurations. The multiple options could be products with different colours, shapes, sizes, or specifications etc.

Take a Mechanical Seal for example. A typical Mechanical Seal can be assembled in a variety of configurations. Each configuration is offered to suit a particular need. The need may be cost driven or technical specification driven.

For the purpose of this application, products with multiple configuration options are termed as “complex assemblies”.

Increasingly, customers are promoting their products over the internet. The internet allows companies to promote their products to customers in all parts of the world, working in differing time zones.

Companies can offer customer service by allowing customers to make product selection decisions based on what product specifications options are offered, at what price and in what time frame (lead-time) they can be supplied.

A further benefit may be provided if the customer can identify what the product will physically look like including the dimensions of the product.

Companies, which offer such a “product selection” service, particularly for complex assemblies, over a common communication system, such as the internet or any similar information technology based network, may attain a competitive advantage.

In certain circumstances, the customer may not know exactly what he needs for an application or particular problem. In a chemical processing industry, a customer, for example a mechanical engineer, may need a sealing device to prevent his equipment from leaking. Such a sealing device may need to operate to the customers exacting parameters. These parameters include the chemical being sealed, its temperature and its pressure.

In such applications, the customer knows his application, but is unsure what sealing product he will need and which materials of construction should be used.

It is deemed considerably advantageous if the customer can identify what product he needs, then determine its price and lead-time, its physical dimensions and appearance all from a remote location or time zone. Furthermore, without the need for human intervention, it is advantageous if the customer is then allowed to place an order, for his selected product, direct into the supplying companies business system.

It will be apparent to an experienced reader, that if a supply company offers such a service, particularly for a complex product, then it will indeed gain a competitive advantage selling and promoting its products.

The following integrated application/invention will be further discussed in detail, with respect to;
the generation of a general assembly or general arrangement drawing of the product, showing its physical size and shape,
the price and availability of the product selected by the customer,
ordering the product direct into the supply company's business system.
the selection of a product for a specific customer duty or request,
   General Arrangement Application

Most technical products, particularly in the engineering sector, are tendered, designed and/or distributed with a General Arrangement drawing of the product.

Said General Arrangement drawings are particularly important to convey what is being offered or sold.

General Arrangement drawings often contain information pertinent to the product being offered. Such information may include at least one view of the product, dimensional information of the product and/or a parts list, particularly relevant for products with more than one component in their assembly.

Further information presented on a general arrangement drawing may include information specific to a customer or application. The industry term for such a general arrangement is a certified drawing.

Practically every industry and sector creates product drawings. By way of example only, in Civil Engineering, general arrangement drawings are created for structures such as bridges, bus shelters or even traffic lights.

Architectural engineering uses general arrangement drawings to illustrate building constructions, office layouts or furniture assembly. Electrical engineering uses general arrangement drawings to illustrate electrical circuits, wiring diagrams or electrical mechanical assemblies such as printers, computers, televisions, plugs or radios.

Automotive engineering uses general arrangement drawings to illustrate vehicle design, engine assembly or a fuel distribution system.

Mechanical engineering is a further example of such a sector, which uses general arrangement drawings to illustrate products. Practically every product from a piece of mechanical handling equipment such as a forklift, to an item of rotating equipment such as a pump, has an arrangement drawing.

Rotating equipment is used to process a variety of liquids in practically every industrial sector from Chemical processing to the Pulp and Paper industry.

There are many parts in a piece of rotating equipment. One such part is a mechanical seal. Mechanical seals are engineered products; often comprising of a number of components assembled in a particular manner. Since mechanical seals are used to seal a variety of chemicals and process fluids, there are many combinations of materials and components that are used in any given generic assembly.

Not dissimilar to most products with multiple variations and combinations of components, creating individual mechanical seal certified general arrangement drawings is a time consuming and an expensive exercise.

For example, if one takes any product range with say fifty product sizes in said range. Each product is offered in one hundred materials combinations and ten colours. The number of individual certified general arrangements would be fifty thousand. Then assume an average company has thirty product ranges each requiring fifty thousand drawings each. It is not practical for any company to create said number of drawings. The number of drawings further increases when the customer requires the general arrangement drawing producing with their respective name and application details. For two hundred customers each with fifty applications each, using the example above, a company would have to create over a billion complex assembly drawings.

By conventional means, depending on the complexity of the product or its assembly, each assembly drawing can take several hours to produce.

A general arrangement application which can produce a certified drawing within a fraction of this time is deemed to be particularly advantageous.

It is deemed to be further advantageous, if said general arrangement application is database driven and accessible to any user at any location/country.

According to the invention there is provided a method of generating an illustration of a first device, the first device being one of a set of devices, the method comprising the steps of:
providing a plurality of illustration templates, each illustration template corresponding to one device of the set of devices;
choosing the illustration template corresponding to the first device; and
modifying the first device illustration template responsive to features of the first device to generate the illustration of the first device.

In one embodiment of the invention the method comprises the step of generating one or more illustration templates.

The plurality of illustration templates may be stored in the form of a database. Preferably the plurality of illustration templates are classed into two or more groups of illustration templates. Ideally the method comprises the step of choosing the group of illustration templates corresponding to the first device before choosing the illustration template corresponding to the first device.

Modifying the first device illustration template may comprise the step of addition of text to the illustration template. Modifying the first device illustration template may comprise the step of addition of dimensions to the illustration template. Modifying the first device illustration template may comprise the step of generating an image in the illustration template. Modifying the first device illustration template may comprise the step of altering an image in the illustration template.

In one case the method comprises the step of storing data relating to the generated illustration of the first device. Preferably the data relating to the generated illustration of the first device is stored in the form of a database.

The illustration may be a two-dimensional (2-D) illustration. The illustration may be a three-dimensional (3-D) illustration.

The first device may comprise a mechanical seal. The first device may comprise a mechanical pump.

In another embodiment the first device comprises two or more parts. One of the parts may comprise a mechanical seal. One of the parts may comprise a mechanical pump.

The invention also provides a computer program product comprising software code portions capable of performing a method of the invention when the computer program product is run on a computer system.

According to another aspect of the invention there is provided a system for generating an illustration of a first device, the first device being one of a set of devices, the system comprising:
a plurality of illustration templates, each illustration template corresponding to one device of a set of devices;
means suitable for choosing an illustration template corresponding to a first device; and
means suitable for modifying the first device illustration template responsive to features of the first device to generate an illustration of the first device.

In one embodiment of the invention the system comprises means suitable for generating one or more illustration templates.

The plurality of illustration templates may be stored in the form of a database. Preferably the plurality of illustration templates are classed into two or more groups of illustration templates. Ideally the system comprises means suitable for choosing the group of illustration templates corresponding to the first device.

In one case the system comprises a user interface. Preferably the user interface is configured to enable a user to choose the illustration template corresponding to the first device. The user interface may be configured to enable a user to specify features of the first device.

In one case the user interface is located remotely from the plurality of illustration templates. Most preferably the user interface is suitable for remote connection to the plurality of illustration templates, for example by means of an internet and/or an intranet connection.

The means suitable for modifying the first device illustration template may comprise means suitable for adding text to the illustration template. The means suitable for modifying the first device illustration template may comprise means suitable for adding dimensions to the illustration template. The means suitable for modifying the first device illustration template may comprise means suitable for generating an image in the illustration template. The means suitable for modifying the first device illustration template may comprise means suitable for altering an image in the illustration template.

Preferably the system comprises a database to store data relating to the generated illustration of the first device.

The illustration may be a two-dimensional (2-D) illustration. The illustration may be a three-dimensional (3-D) illustration.

In one case the first device comprises a mechanical seal. In another case the first device comprises a mechanical pump.

In a preferred embodiment the first device comprises two or more parts. One of the parts may comprise a mechanical seal. One of the parts may comprise a mechanical pump.

The system may be a computer system.

The invention also provides an integrated application, which comprises of at least one database, in which said database includes product selection functionality, and/or commercial selection functionality and/or general arrangement creation functionality for a complex product which contains at least one component in its assembly.

The integrated application preferably comprises of at least one product database, said database communicates to a certified general arrangement application via at least one user specific database, for a complex product containing at least one component in its assembly. Said general arrangement application may store user raw data only, said user data is linked to a drawing template thereby allowing accurate drawing representation with minimum data file size.

In one case said application creates at least one specific product reference code relating to the user defined information. Preferably said application creates at least one specific product reference code relating to user defined information, said reference code may subsequently be used in a secondary application such as a business system, or used in a further stage of the same general arrangement application.

In one embodiment said application automatically populates a template drawing with material information and dimensional information. Ideally said application automatically populates a mechanical seal template general arrangement drawing with, at least, material, dimensional and user specific information.

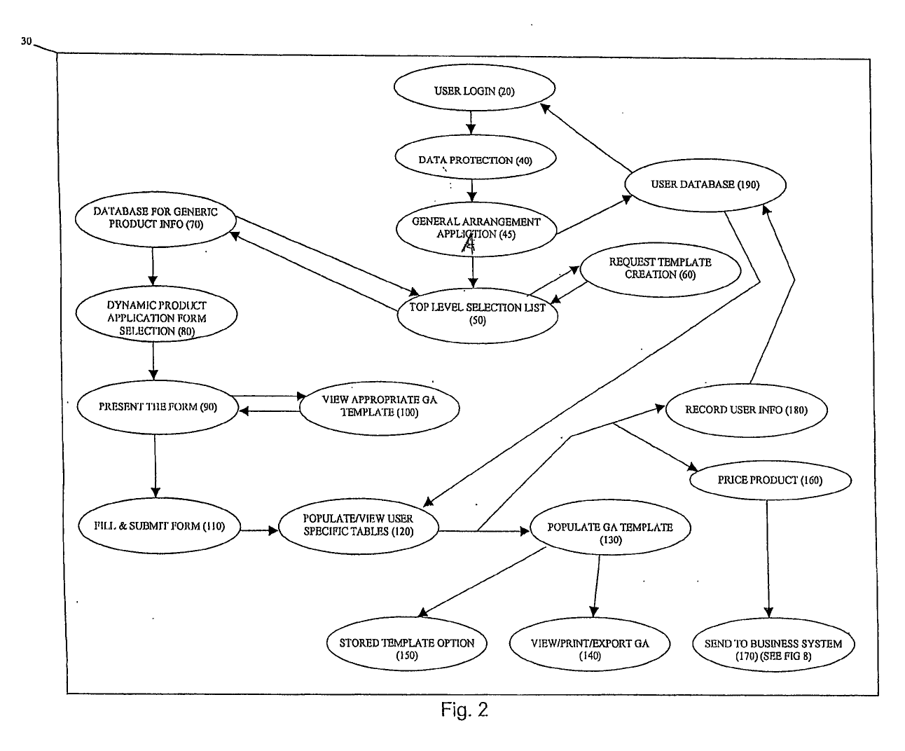

The general arrangement application may be used as an integrated or stand alone application in either a single user or multi-user mode, according to any of the preceding claims substantially as described here with reference to FIGS. 2 to 5 of the accompanying drawings.

In another case the integrated application comprises of a product selection application, said application communicates to at least one selection criteria database, said selection criteria database contains data which is referenced to at least one product, said product selection application allows the selection of a complex product containing at least one component from a finite list of selection criteria. Preferably said product selection application includes at least one, or a combination of, an equipment database, and/or operational database, and/or competitor database and/or accompanying product database, and/or a case history database. Ideally said product selection application integrates the selection process of more than one product, including accompanying products, thereby facilitating reiterative selection of either, or all products, and whether the product origin is of the supply company or that of a different supply company.

Said application may create at least one specific product reference code relating to the user defined information. Most preferably said application creates at least one specific product reference code relating to user defined information, said reference code may subsequently be used in a secondary application such as a business system, or used in a further stage of the same application.

The product selection application may communicate directly with a drawing application, whereby said product application shares the user specific information, created.

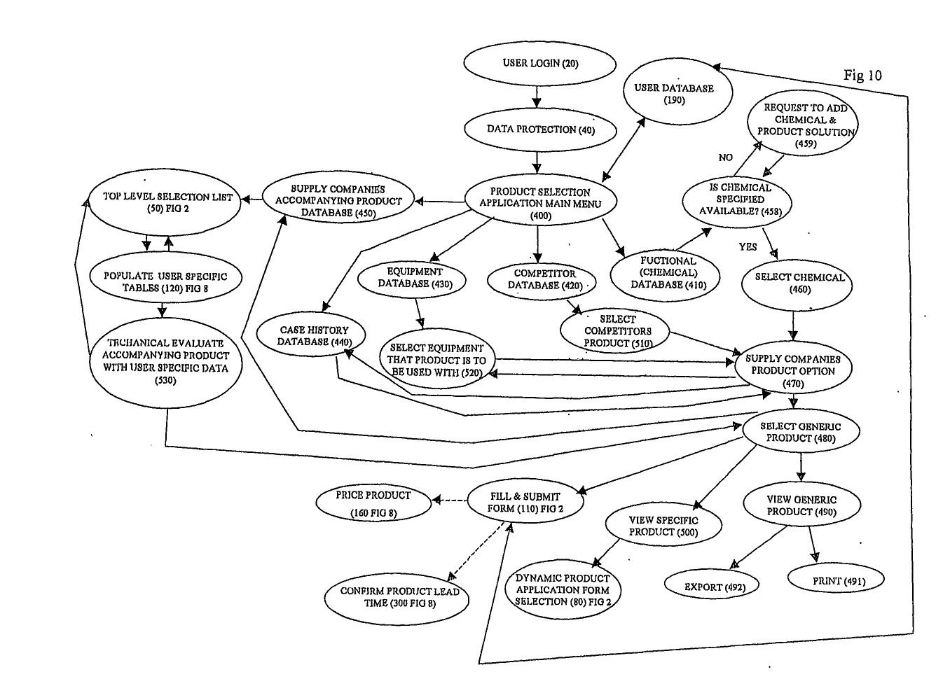

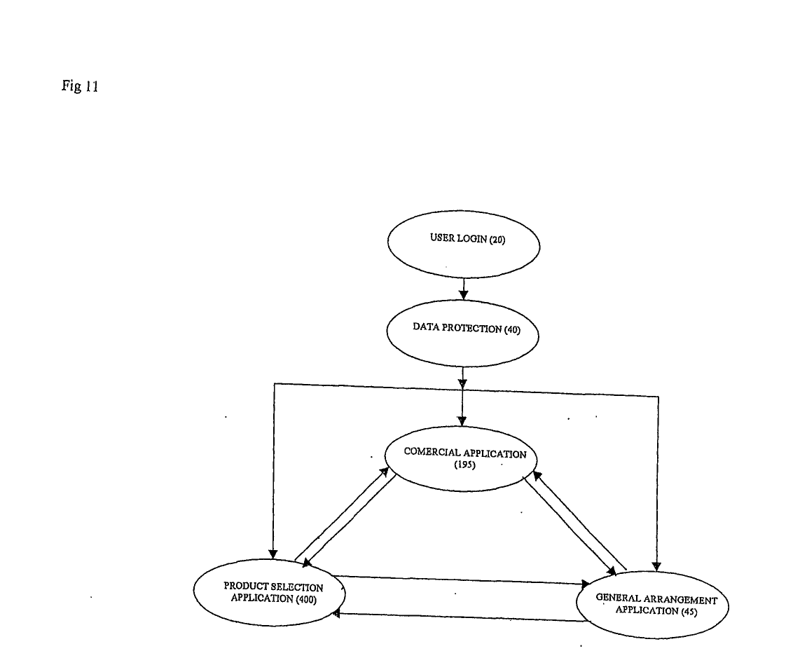

The product selection application may be used as an integrated or stand alone application in either a single user or multi-user mode, according to any of the preceding claims substantially as described here with reference to FIGS. 10 to 11 of the accompanying drawings.

In another embodiment the integrated application comprises of a commercial application, said application communicates to at least one commercial database, said commercial database contains data which is referenced to at least one product, said commercial application allows the commercial interrogation of a complex product containing at least one component. Preferably said commercial application includes at least one, or a combination of, a product pricing database, and/or product availability database, and/or the ability to integrate to a supply companies business system. The commercial application may integrate the selection process of more than one product, including accompanying products, thereby facilitating reiterative selection of either or all products, and whether the product origin is of the supply company or that of a different supply company

Preferably said application creates at least one specific product reference code relating to the user defined information. Ideally said application creates at least one specific product reference code relating to user defined information, said reference code may subsequently be used in a secondary application such as a business system, product selection application, or used in a further stage of the same application.

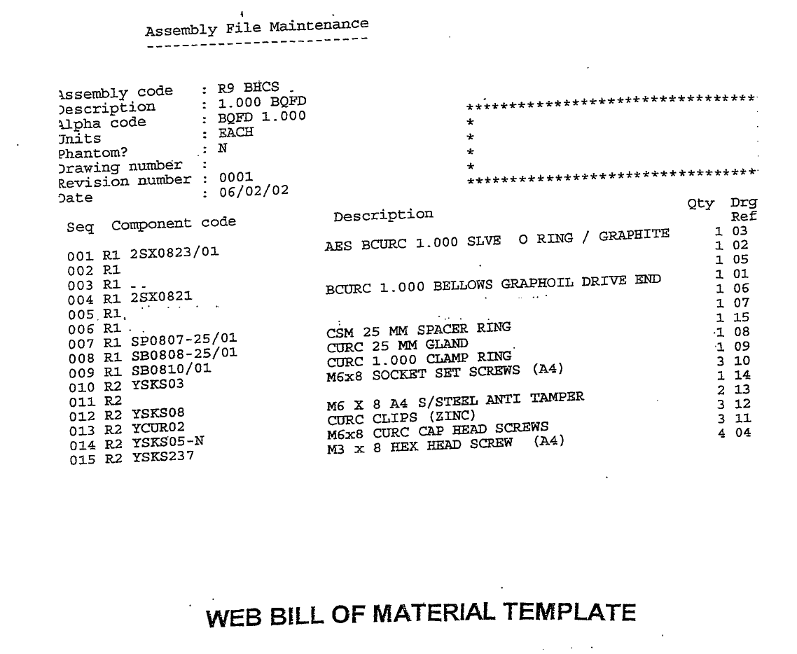

The commercial application may communicate directly with a drawing application, whereby said commercial application shares the user specific information, created. The commercial application may be used as an integrated or stand alone application in either a single user or multi-user mode, according to any of the preceding claims substantially as described here with reference to FIGS. 6 to 9 of the accompanying drawings.

The invention also provides a drawing application, and/or a product selection application, and/or a commercial application whereby said application is created in an internet efficient programming language. Said internet efficient programming language may be Cold Fusion, Java script, Visual Basic, Java, HTML or Active Sever Pages or a combination of any aforementioned languages.

The invention provides an integrated product selection, commercial and general arrangement application substantially as described here with reference to FIGS. 2 to 11 of the accompanying drawings.

The present invention may be used as a stand-alone application or accessed over the internet to more than one user.

The present invention allows any one user to create a certified general arrangement of a product, within minutes of entering their specific product configuration requirements.

Furthermore, the invention may automatically create a unique reference code configured to the product requested. This unique reference code may be subsequently used to order the product required. Furthermore, if so desired, this unique product reference code may be directly sent into a suitable application, whether part of the same application or an application, which communicates with, said primary application.

An example of such, is where the product reference code is imported into a companies business system. Such a code could then be used to trigger an assembly build request or product tender/estimation.

It will be obvious to the experienced reader that once a unique and traceable product reference code is created, particularly electronically, said reference might be read or exported into any suitable application for further analysis or use. The potential applications where this invention may be applied are possibly endless.

In particular this functionality makes automatic product ordering to a certified specification, a possible option. Furthermore the reference code could be used to trigger a request for product manufacture or a sales order despatch. Such an automatic process would require minimal or zero human invention.

An experienced reader will therefore note that such an application has major business advantages in that business-operating costs could be reduced and I or customer service levels could be increased.

The invention is further described with the aid of the following drawings.

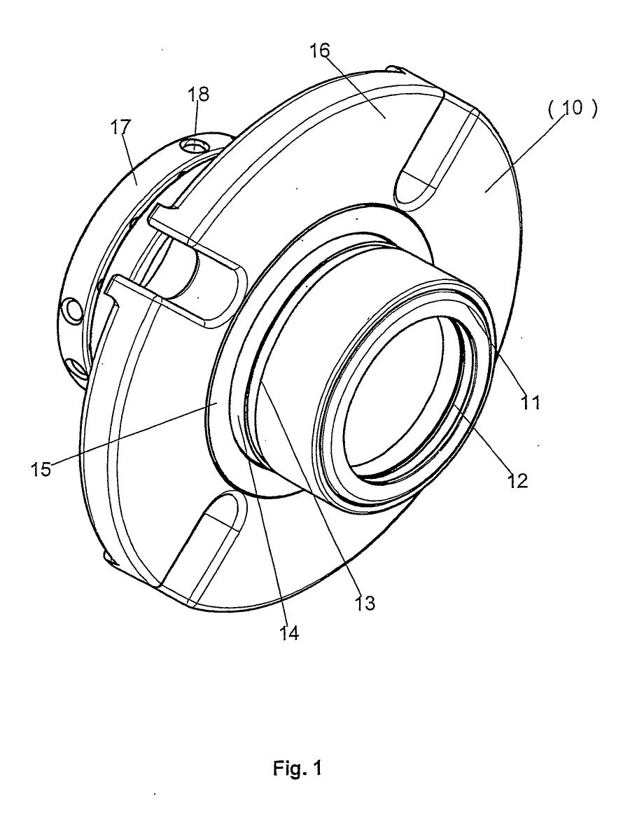

FIG. 1, illustrates a typical product assembly, such as a mechanical seal, comprising of more than one possible assembly configurations.

FIG. 2, illustrates a logic tree for the general arrangement application.

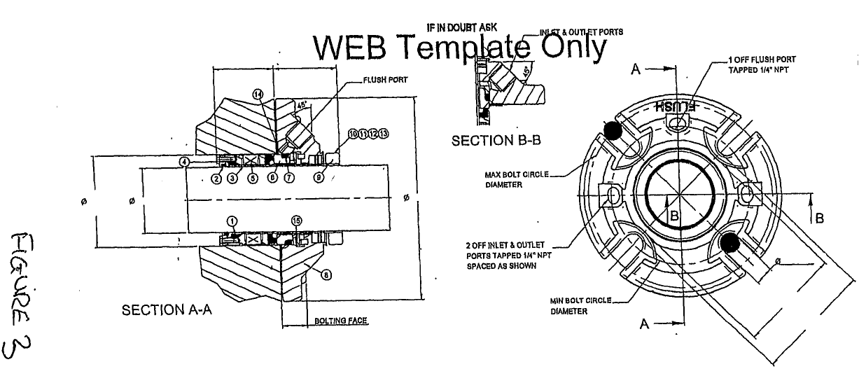

FIG. 3, illustrates a general arrangement template drawing for a product with more than one possible assembly configuration.

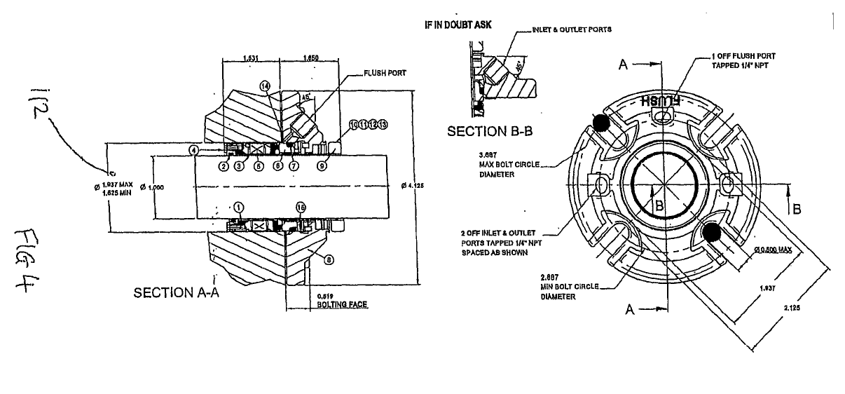

FIG. 4, corresponds to FIG. 3 and illustrates a certified general arrangement, completed from a template, for a product with more than one possible assembly configuration.

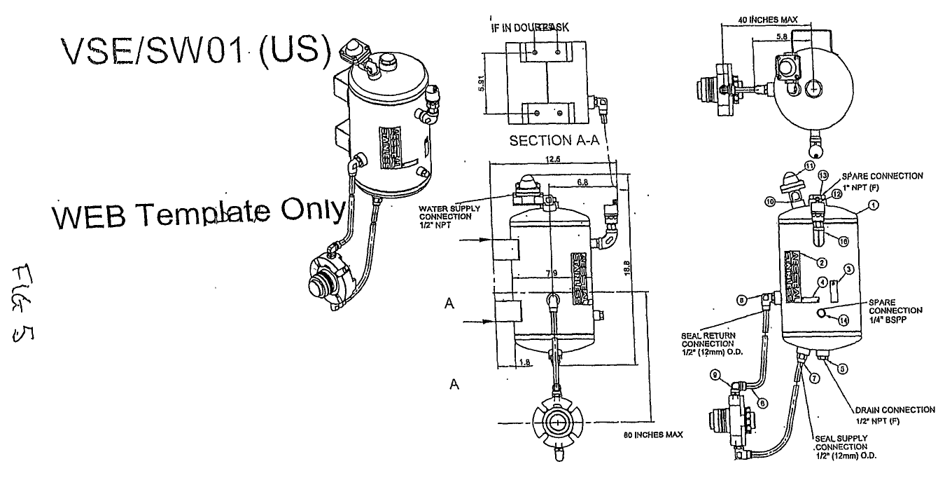

By way of example only, FIG. 5, illustrates a certified general arrangement for another product with multiple assembly configurations.

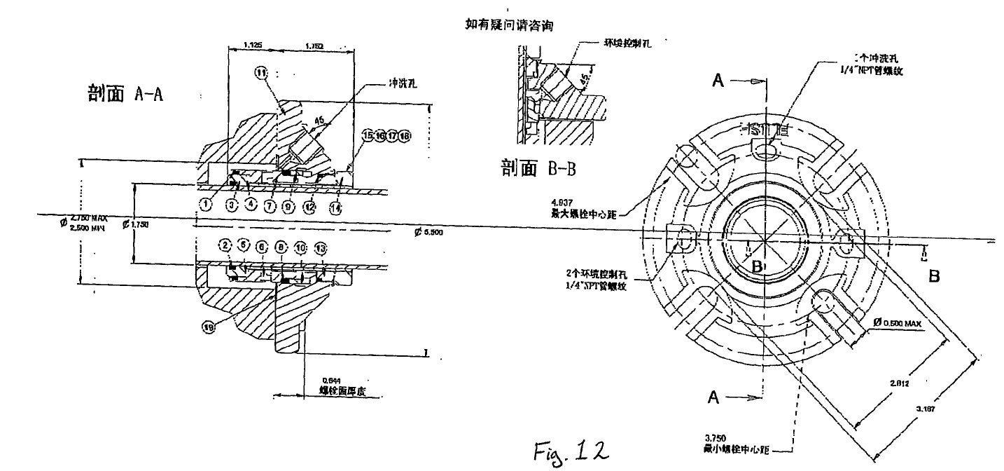

By way of a further example only, FIG. 12 illustrates an example of a certified general arrangement for a similar product, presented in a different language.

For simplicity, the general arrangement application will be further explained referring to product with more than one possible variable. As an example only, the product used for this purpose will be a mechanical seal typically used to seal an item of rotating equipment such as a process pump.

FIG. 1 illustrates an isometric view of a mechanical seal (10). Said mechanical seal (10) is assembled using a number of individual components. Such components include a sleeve (11), sleeve elastomer (12), rotary seal face (13), stationary seal face (14), gland insert (15), gland (16) and clamp ring (17). The clamp ring (17) contains setscrews (18). An experienced reader will appreciate that there are a number of further components not shown.

As mechanical seals (10) are used in a wide variety of applications, a generic design and respective components may be offered in a wide variety of material combinations. Each material offers certain advantages in a given application. For example, the sleeve (11) may be offered in three materials, the sleeve elastomer (12) may be offered in seven materials, the rotary (13) and stationary (14) faces may be offered in five materials each etc.

Certain customers, particularly engineers, require certified general arrangement drawings with quotation tenders and/or final delivery of the product. A certified drawing should generally only illustrate the particular material combinations requested by the customer. Typically, generic general arrangement drawings, which show multiple options, are not specific enough and therefore are not normally accepted by a customer.

This creates a huge problem for a company with many product ranges, each with multiple configurations.

FIG. 2, of the invention shows a logic tree of a general arrangement application which enables a user to create certified drawings.

From FIG. 2, a user logs on (20) to the application (30). When accepted through an appropriate data protection review (40), typically a password check/authorisation, the user enters the general arrangement application (45) and selects a generic option from a top-level selection list (50).

Should the required generic option not be available from the top-level selection list (50), the user may elect to send a request (60) for the missing option to be added.

Once a user selects a generic top-level option (50), the request is sent to a database (70), which contains data relating to the top-level item selection list (50).

The request, via the database (70) then triggers a dynamic file (80), for example a Cold Fusion Mark-up Language/CFM file. This dynamic file (80) relates to the top-level item (50) selected.

The dynamic file (80) presents a relevant form (90), which is configured to select an appropriate general arrangement template (100).

An example of a general arrangement template (100) is shown in FIG. 3. Said template (100) contains the generic illustration of the product, with the variable options omitted. By way of example only, said template (100) is stored as a Form Document Format (FDF) or a Portable Document Format (PDF) file.

From FIG. 2, the user completes the form (90) with the product configuration requested. Form (90) will contain either pre-defined fields or non-defined fields, or a combination of both pre-defined or non-defined fields.

Preferably the form (90) contains pre-defined option selection boxes, prompting the user to select a product configuration from a finite option list. However certain customer specific fields may be required.

These are typically not product related, however are part of the drawing certification format, required by the customer. These are non-defined fields.

From FIG. 3, the pre-defined product configuration options (101) typically appear in the part list (102) on template (100). Non-defined, customer specific fields (103) typically appear in the customer certification title block (104) on template (100).

Referring back to FIG. 2. Once the form (90) is completed, to the extent the user is able to complete the form, the user submits (110) the data. The application then populates the requested user data into a user specific table (120). This user specific table (120) may be stored locally or centrally on a network. The user specific table (120) allows the user, at a later stage, to browse through the general arrangements that they have specifically created.

Upon completion of writing the information to the user specific table (120), the application then populates the selected general arrangement template (FIG. 3, 100) with the user specific information. This is represented in FIG. 2 by populate template stage (130).

From FIG. 3, the application then further populates the template (FIG. 3, 100) with a relevant product reference code (105). The product reference code (105) is created by comparing each user-defined option against a pre-defined data table.

FIG. 4 illustrates a user completed certified general arrangement drawing containing both requested finite product data (106) and infinite customer data (107). FIG. 4 also illustrates at least one, generated product or order reference code (108) and optional assembly reference code (109).

Furthermore, from FIG. 4, a skilled person will also note that a unique suffix code (111) has been attached to the drawing number. This differentiates identical generic product drawings with contain different assembly configuration information. This is deemed to be advantageous when, for example, an engineering company is required to be quality assured by an external approval body such as Lloyds.

It should be further noted from FIG. 4, that the physical dimensions (112) of the product assembly have also been entered onto the certified customer product drawing. This shows the exact dimensions of the product requested by the user. The presentation of said exact dimensions is deemed to be advantageous compared to the conventional tabular approach. In the conventional approach, a typical user has to carefully and accurately read data in complex tables. This can lead to errors and misunderstandings.

The specific information (106) contained in FIG. 4, together with the customer information (107) and representation of product, creates a general arrangement drawing, which is deemed to be certified.

Referring back to FIG. 2. When the customer certified drawing is created at the data population stage (130), the user may elect to view (140), print and/or export the general arrangement. Furthermore, the user may elect to store (150) the certified drawing for future use or electronic distribution.

An important feature of the invention is that, unless the user specifically requests to store (150) the certified drawing, the application will only retain the user created raw data. The application could be easily adapted to retain the user created certified drawing, however it is deemed particularly advantageous to only save the raw data as this considerably reduces the size of the electronic file.

An experienced person will appreciate that a typical group of users may create fifty thousand certified drawings in a small time period. If each certified drawing contains the generic template, of the file size 70,000 Bytes and user raw data size 100 Bytes, the electronic storage space required would be over 3.5 Giga Bytes (35,000,000,000 Bytes). This would be very difficult to manage over any realistic time period.

In general the larger the individual file and the more cluttered the electronic storage space, the slower the application. This is particularly disadvantageous when operating a multi-user version of the application from a remote site accessed by a low-technology data transfer link.

One can therefore see a considerable advantage if only the user raw data (100 Bytes) is electronically stored and the application retrieves a common general arrangement template (100) each and every time the user wishes to view the user created certified drawing.

Referring back to FIG. 2. At the “populate user table” stage (120), a further feature of the invention is that the user may elect to retrieve a price of the product from a product price list database (160).

Should the user request need to be further processed, the user may submit the user defined information and specific product order reference code (FIG. 4, 108) to a companies business system (170). Considerable corporate advantages may be then realised, as human intervention can be reduced/eliminated from the order execution process.

Referring back to FIG. 2. Once the user table (120) is populated with the user specific information, the user information is recorded (180) and stored in a database (190) for future retrieval/use.

It is considered self evident to an experienced reader that the invention may be employed for any type of product whether an individual component, a sub-assembly or full assembly. A further example of a different product is shown in FIG. 5.

Furthermore, the invention may be used as a single user, stand-alone application, or preferably, used as a multi-user, networked or server based application.

While the application is not limited to the generation of mechanical seal drawings, it is deemed particularly advantageous since a typical mechanical seal has many assembly configurations.

At the time of issuing this application, preferably the general arrangement application is created in a cold fusion programming language, however equally, it may be created in any programming language including, but not limited to, Java script, Visual Basic, Java, HTML and Active Sever Pages (ASP). With advances in technology, new programming software will be developed. An experienced reader will note that the concept of the invention may be presented using any suitable programming means.

The illustrations (FIGS. 3 to 5) show two-dimensional representations of products. It should be noted that the invention could be used in a similar manner to what has be described above, however with three dimensional representations, video and/or animated representations of products.

In the multi-user mode, a skilled person will note that the invention enables a user to create a product reference code. Said product reference code, particular to their requested product, may then be used in any application where it can be of further benefit. This has obvious commercial advantages.

One particular use of the product reference code, it to confirm the availability or lead-time of the product selected. This is described in the commercial application below.

Commercial Application

The commercial application will be further described with reference to the following drawings;

FIG. 6, illustrates an example of a generic Bill of material template sheet, for one particular product in one particular size.

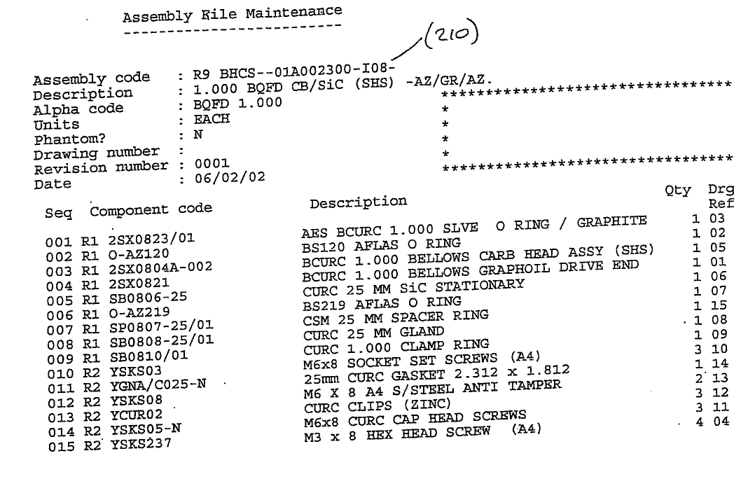

FIG. 7, corresponds to FIG. 6, and illustrates an example of a customer configured Bill of material sheet, for one particular product in one particular size.

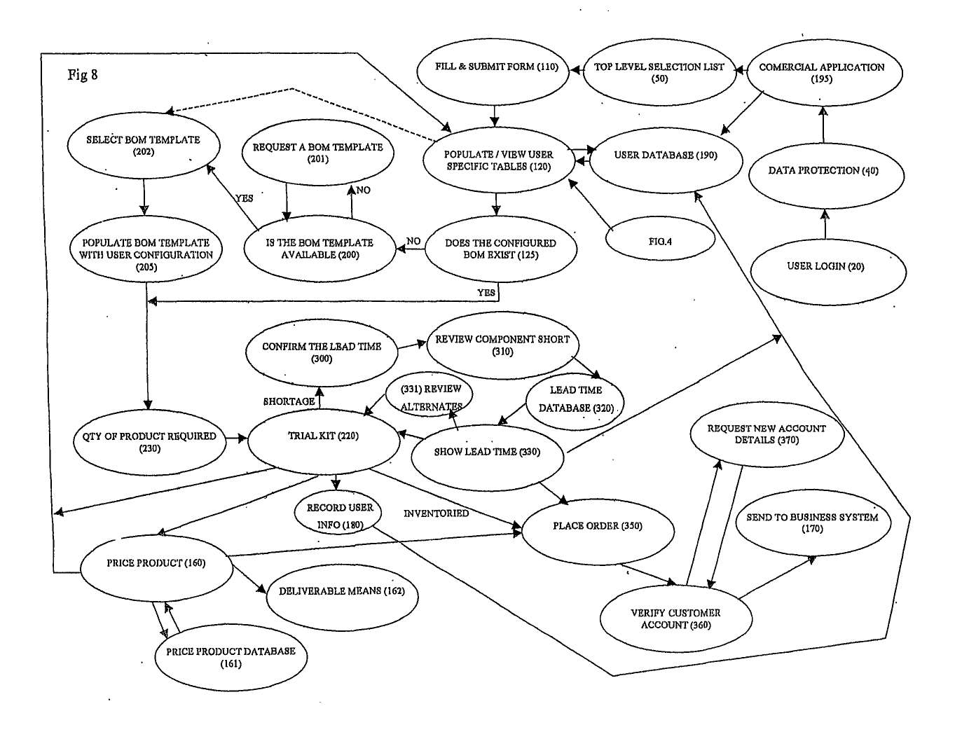

FIG. 8, illustrates a logic tree for the product commercial application, detailing product availability and price functions.

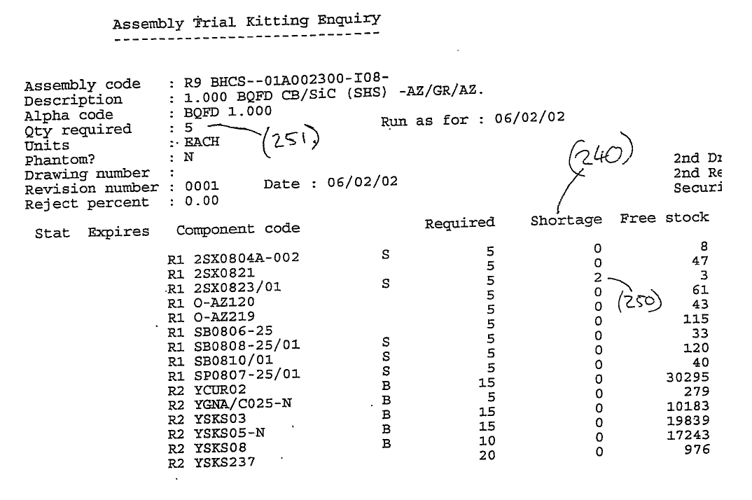

FIG. 9, corresponds to FIG. 7, and illustrates an example of a customer configured Trial Kit sheet, for one particular product in one particular size.

Complex assemblies typically have many components which are used in their assembly. Each of the components, may also be used in a variety of other assembly configurations. Such components, which can be used in a variety of configurations, are termed modular.

Complex assemblies can have many hundreds of thousands of configurations. As previously discussed, an example of a complex assembly is a mechanical seal. If a mechanical seal is offered in fifty seal sizes, each with sixteen seal face combinations and fifty elastomer combinations, there will be 40,000 different assembly configurations.

Typically, each of the 40,000 assembly configurations require a bill of material. A bill of material is a detailed parts list showing a full breakdown of all the components which make up the complex assembly.

Each individual component may or may not be inventoried at any one moment in time.

In order for a customer to determine the availability of their selected product, a detailed bill of material of that product must be firstly created. This bill of material is configured to the customer's request. Bills of materials generally reside in dynamic application such as a supply company's business system.

Bills of material generally show more detail than an equivalent parts list in a drawing application.

Over and above the typical drawing parts list, Bills of material typically include component stock code details, the location or warehouse where component resides in the business system, the packing and boxing requirements, the documentation needed to accompany the product assembly etc.

An experienced person will appreciate that parts lists in drawings are conventionally static, however, if deemed appropriate, such parts lists also may be linked to a supply company business system.

Preferably, dynamic Bills of material which are linked to the company's business system are employed.

It will be noted that it is not feasible for any company to create 40,000 Bill of Materials covering all the possible configurations of a single product range. This is increasingly impractical if one considers that a typical company may have many product ranges. For example, a company which supplies mechanical seals may have 30 product ranges. This generates a requirement to create over 1.2 million bills of material. If each bill of material is not created, then there is a possibility that the customer will not be able to confirm the availability of his selected product, via the application which is linked to the supply company's business system.

The invention addresses this issue in one of two ways.

The invention firstly determines if the bill of materials already exists in the companies business system.

If the customer selects a product where the bill of material already exists in the companies business system, the invention confirms the availability of the complex assembly by identifying if each component, pertaining to the complex assembly, is inventoried. This will be discussed later with reference to FIG. 9.

If the customer selects a product where the bill of material does not already exists in the companies business system; the invention automatically creates a new bill of material.

From FIG. 8—once again the user logs on passes through the data protection (40) check and then selects to enter the commercial application (195).

The commercial application will allow the user to browse the user database (190), and select previously defined product assembly configurations.

If the application is used in its fully integrated mode, the user database (190) shares the same information defined in enter the general arrangement application (30) defined in FIG. 2, or the product selection database (400) defined later in FIG. 10.

Referring back to FIG. 8. If the user creates a new entry, he may do so from selecting a product from the Top level selection list (50), submit the form (110) and populate the user specific tables (120).

The application then confirms whether the user requested BOM exists (125). If the user requested BOM does not exist, the application confirms if a BOM template exists (200).

The application creates the customer specific Bill of Material using a suitable selected (202) Bill of material template. If no (200) template exists the application sends a request (201) to the supply company for a template to be added. In general if the supply company is offering a product then it will ensure a template exists for that product. An example of such template is shown in FIG. 6.

FIG. 6 is an example of a mechanical seal Bill of material template. Each product range incorporating, for example, fifty product sizes, has fifty bills of material templates created. The template contains the components which are not variables/which do not change with the product configuration.

FIG. 6 is an example of a product template, for a generic product, which is termed a BQFD. The selected product size is 1.000″.

From FIG. 6, the Bill of material template shows the generic components which relate to the customers selected product type and size. As the customer has completed and submitted his request to a user specific table (120) from FIG. 8, this configured data is used to complete a copy of the Bill of material template. This configured Bill of material is shown in FIG. 7.

It will be noted from FIG. 7, that the assembly reference code (210) has been populated in the configured Bill of material. This assembly reference code (210) is identical to the assembly reference code (109) in FIG. 4.

FIG. 8 illustrates the logic tree for the Bill of material process.

From FIG. 8, when the customer-configured bill of material is complete (205), the user enters the quantity of products (230) he requires. The user then has the option to confirm the product lead-time (300) via an “assembly trial kit” (220). The components, which are not inventoried, are appropriately flagged.

By way of example only, FIG. 9 illustrates an assembly trial kit sheet, showing the components which are not inventoried. These components are shown in the “shortage column” (240). For the example, the customer will note that component code 2SX0823/01 has a shortage (250) of two components. This shows that the customer can only have three products from inventory, not five that he requested (251).

Referring back to FIG. 8. The customer then has the option to confirm the lead-time for the outstanding products. The invention then reviews the components which are short (310), compares the component type against a lead time database (320), and informs the customer with an anticipated despatch date (330).

If the product lead-time is unacceptable, the invention allows the user to review alternate options (331). Typically such alternate options cover alternate materials of construction as well as alternate products. The user is then allowed to trial test (220) the alternative product option selected.

Built in rules enable the user to select alternatives based on suggestions made by the system. Alternate materials of construction will be offered on the basis that the specification of the product is acceptable to the application. Alternate products will be offered on the basis that the dimensional size of the product and the materials of construction are acceptable to the application.

If the lead time (330) is acceptable the user can either place an order (350) or return to the user database (190).

An experienced reader will note that the invention when used with a global communication tool such as the internet allows a user to make real time product availability decisions without the need for the supply company involvement. Such a user could be sited anywhere in the world, in any time zone.

In certain situations, this invention is particularly advantageous as it enables the supply company to provide valuable customer service. An example of this added value is when a chemical processing company has a mechanical seal failure at 3.00 am GMT. An customer can then select a product from a supply company, check its availability, check its price and order the mechanical seal within minutes of entering the application/invention.

From FIG. 8, it will be noted that at the trail kit (220) stage, the customer may also request to price (160) his configured product. The product assembly code (FIG. 4, (109)), created by the customer is cross referenced to a product pricing database (FIG. 8, (161)). The customer is then given the product price (160) by any deliverable means (162) including electronically, visually, or via a printout.

Once again, if the product price is unacceptable, the invention allows the user to review alternate options, as discussed earlier.

It will be further noted from FIG. 8, that the user can elect to send the product order request (350) to the supply company business system (170). This order request (350) will typically be processed through a customer account verification database (360). If the customer is new to the supply company, a request new account application form (370) is sent to the customer. The user completes an application form and returns it back to the verification process (360).

Once the customer account is verified, the order request (350) is sent to the supply company's business system (170) for further processing.

Once the order enters the supply companies business system, the customer order may be directed straight to the assembly build team, the dispatch area, or any other part of the business which requires the order information.

Product Selection Application

The product selection application will be further described with reference to the following drawings;

FIG. 10, illustrates a logic tree for the product selection application.

FIG. 11, illustrates a logic tree for the holistic application showing the integration between the product selection application, general arrangement application and the commercial application.

An integral part of the application is the functionality that enables a user to specify their product requirement in a complex application.

The experienced reader will recognise the difficulty in getting to a product specification based on many variables.

By way of example only, in many engineering applications, products must be specified with regard to pressures, temperatures, chemical compatibility's, dimensions, competitors equivalents, equipment that the product must be fitted too etc.

By drawing on stored data in a number of data areas, simple rule sets can be used to specify complex assembly products for a given application. This is particularly advantageous to an organisation as it removes the need for highly trained members of staff in answering simple specification questions for customers.

Conventionally, each product specification process may take several hours without such knowledge based management systems.

From FIG. 10, the user logs on (20) the to application and is processed through the data protection field (40), as described previously.

The user is then presented with the product selection main menu (400). From said main menu, the user can elect to enter a number of databases, depending on the information he has.

For example, when selecting a product from a supply company, the user may wish to choose a product by;
Entering the equipment where the product is to be installed (430)
Entering competitor equivalent products (420)
Entering the information or environment where the product is to function or operate (410)
Browsing case histories where products have been previously supplied (440).

In addition, many products work in conjunction with other accompanying or “sister” products. Said accompanying products often compliment the former product's performance.

An example of this is a computer. A computer base unit can have multiple accompanying products such as a monitor or keyboard. Different monitor specifications can improve the computer base unit's performance to a greater or lesser degree. The monitor and the computer base unit have therefore an interdependent relationship.

It is therefore considered self-explanatory, that a user may select a product with due consideration to an accompanying product. This facility is therefore a further option of the product selection application and shown in FIG. 10, (450).

Given this functionality, an experienced reader will note that the aforementioned product selection methods are examples only. Many additional or different product selection methods can be applied to the application depending on the product being offered.

Therefore from FIG. 10, a user can enter the functional database (410). As an example only, this database contains multiple chemical descriptions. In the chemical processing industry, many thousands of different chemicals are processed. It is critical that products with the correct materials of construction are selected for such applications.

Therefore the user in the aforementioned example, browses through the chemical database (410) until he selects (460) the chemical he requires his product to function with.

Where an application cannot be specified from the existing knowledge within the system, the supply company's in-house team could then produce a specification and importantly, add that solution and knowledge into the application.

From FIG. 10, if the chemical required is not present, (458) in the chemical database (410), the user can request the chemical and the appropriate product solution/offering, to be added (459).

This functionality suggests that any single application, even in very complex environments, need only be solved once. The experienced reader will again recognise the value of this process.

From FIG. 10, once the user has selected the chemical (460), the application offers the user the preferred product option (470). It also offers alternate product offerings, which are second and third choice solutions.

Once the user selects the generic product (480) offered, he has the option to view (490), export (492) or print (491) the generic product. Equally, since the invention can be run as an integrated application, the user may complete the dynamic product application selection form (80) outlined in FIG. 2. This turns the “generic” product offering to a specific user product offering, typically including product size.

From the dynamic application selection form (80), the user may then create a general arrangement drawing, as previously described.

Returning to the main menu (400) in FIG. 10, the user can elect to browse the competitor database (420). Often, users wish to replace products that they have previously used. The user may be aware of the competitor's product but may be unaware of the direct equivalent product from the supply company.

From FIG. 10. In the integrated mode, the user may also fill and submit form (110) and confirm commercial information such as product price (160) and product lead time (300).

Once a competitor's product is selected (510), the user has the option to review the supply company's equivalent (470). This application functionality is extremely valuable given that the supply company may be a new player in an established industry.

Equally, the user has the option from the main menu (400), to review the equipment database (430). This equipment database (430) contains the details of the equipment where the supply company's product may be fitted.

Once again, the user may know the equipment details but be unaware of which products, from the supply company, are available for his piece of equipment. After selecting the appropriate equipment details (520), the user is offered a finite list of products, which may be applied to his equipment.

Furthermore, from the main menu (400), or from a number of other related fields such as the supply company's product option menu (470), the case history database (440) may be browsed. This case history database (440) allows the user to view previous examples of products working;
With different types of equipment,
in place of competitors products,
in functional or operational environments, etc.

This functionality offers the user/customer an extra dimension of customer service and confidence to switch to the supply companies products.

As previously discussed many products work in conjunction with one or more accompanying products. Such accompanying products may be from the supply companies accompanying product range, or from a different supply company.

It should be noted that the invention has the ability to link to more than one accompanying product database, whether part of the supply company, or not.

From FIG. 10, products may be selected from the accompanying product database (450), by any of the previously described product selection methods.

Where product performance is dependent on the selection of an accompanying product, an experienced reader will note the inter-dependant, re-iterative selection functionality of the invention.

By example only, this inter-dependant relationship is illustrated by the feedback loops between the technical evaluation of an accompanying product stage (530), select generic product stage (480), and the accompanying product database (450).

As shown in FIG. 10, it will be obvious to the experienced reader that price, availability and general assembly details of the accompanying product can be established since the invention may be run as a totally integrated package.

Equally, an experienced reader will note that any of the aforementioned applications;
the general arrangement application,
the commercial application, and/or
the product selection application, may be run as an individual application in their own right, or as integrated applications.

It will be noted, that the invention, particularly the integration of all three applications over a suitable communication network, covering more than one user, allows the supply company considerable customer service advantages.

The fully integrated aspect of the invention, particularly, but not limited too, the three applications, is shown in FIG. 11.

1-44. (canceled)

45. A method for generating an illustration of a first device, said first device being one device of a plurality of devices, said method comprising the steps of:
providing a plurality of illustration templates with each illustration template of said plurality of illustration templates corresponding to one device of a plurality of devices;
choosing one said illustration template corresponding a first device of said plurality of devices; and,
modifying said illustration template corresponding to said first device in response to features of said first device for generating an illustration of said first device.

46. The method for generating an illustration of a first device according to claim 45, wherein said plurality of illustration templates are stored in a database form.

47. The method for generating an illustration of a first device according to claim 45, wherein said step of modifying said illustration template corresponding to said first device comprises the step of adding text to said illustration template.

48. The method for generating an illustration of a first device according to claim 45, wherein said step of modifying said illustration template corresponding to said first device comprises the step of adding dimensions to said illustration template.

49. The method for generating an illustration of a first device according to claim 45, wherein said step of modifying said illustration template corresponding to said first device comprises the step of generating an image in said illustration template.

50. The method for generating an illustration of a first device according to claim 45, wherein said step of modifying said illustration template corresponding to said first device comprises the step of altering an image in said illustration image.

51. The method for generating an illustration of a first device according to claim 45, further comprising the step of storing data pertaining to said illustration of said first device following generation of said illustration.

52. The method for generating an illustration of a first device according to claim 45, wherein said illustration of said first device is a two-dimensional illustration.

53. The method for generating an illustration of a first device according to claim 45, wherein said illustration of said first device is a three-dimensional illustration.

54. The method for generating an illustration of a first device according to claim 45, wherein said first device comprises a mechanical seal.

55. The method for generating an illustration of a first device according to claim 45, wherein said first device comprises a mechanical pump.

56. The method for generating an illustration of a first device according to claim 45, wherein said first device comprises, at least, a first part and a second part.

57. The method for generating an illustration of a first device according to claim 56, wherein said first part of said first device is a mechanical seal.

58. The method for generating an illustration of a first device according to claim 56, wherein said second part of said first device is a mechanical pump.

59. A computer software program for executing a method for generating an illustration of a first device, said first device being one device of a plurality of devices, said method comprising the steps of:
providing a plurality of illustration templates with each illustration template of said plurality of illustration templates corresponding to one device of a plurality of devices;
choosing one said illustration template corresponding a first device of said plurality of devices; and,
modifying said illustration template corresponding to said first device in response to features of said first device for generating an illustration of said first device.

60. A system for generating an illustration of a first device, said first device being one device of a plurality of devices, said system comprising:
a plurality of illustration templates with each illustration template of said plurality of illustration templates corresponding to one device of a plurality of devices;
means for choosing one said illustration template corresponding a first device of said plurality of devices; and,
means for modifying said illustration template corresponding to said first device responsive to features of said first device for generating an illustration of said first device.

61. The system for generating an illustration of a first device according to claim 60, wherein said plurality of illustration templates are stored in a database form.

62. The system for generating an illustration of a first device according to claim 60, further comprising a user interface having means for enabling a user to specify features of said first device.

63. The system for generating an illustration of a first device according to claim 60, further comprising a user interface located remotely from said plurality of illustration templates.

64. The system for generating an illustration of a first device according to claim 60, wherein said means for modifying said illustration template corresponding to said first device includes means for adding text to said illustration template.

65. The system for generating an illustration of a first device according to claim 60, wherein said means for modifying said illustration template corresponding to said first device includes means for adding dimensions to said illustration template.

66. The system for generating an illustration of a first device according to claim 60, wherein said means for modifying said illustration template corresponding to said first device includes means for generating an image in said illustration template.

67. The system for generating an illustration of a first device according to claim 60, wherein said means for modifying said illustration template corresponding to said first device includes means for altering an image in said illustration template.

68. The system for generating an illustration of a first device according to claim 60, further comprising a database for storing data pertaining to said illustration of said first device following generation of said illustration.

69. The system for generating an illustration of a first device according to claim 60, wherein said illustration of said first device is a two-dimensional illustration.

70. The system for generating an illustration of a first device according to claim 60, wherein said illustration of said first device is a three-dimensional illustration.

71. The system for generating an illustration of a first device according to claim 60, wherein said first device comprises a mechanical seal.

72. The system for generating an illustration of a first device according to claim 60, wherein said first device comprises a mechanical pump.

73. The system for generating an illustration of a first device according to claim 60, wherein said first device comprises a mechanical pump and mechanical seal.
